(19) United States
(12) Patent Application Publication
(10) Pub. No.: US 2006/0034423 A1
(43) Pub. Date: Feb. 16, 2006

(54) Surgical microscope

(76) Inventors: Juergen Pensel, Altstaetten (CH); Ulrich Sander, Rebstein (CH)

Correspondence Address: HODGSON RUSS LLP, ONE M & T PLAZA, SUITE 2000, BUFFALO, NY, 14203-2391, US

(21) Appl. No.: 11/120,606

(22) Filed: May 3, 2005

Related U.S. Application Data
(63) Continuation-in-part of application No. 10/374,365, filed on Feb. 25, 2003.
Application No. 10/374,365 is a continuation of application No. 09/529,144, filed on Apr. 7, 2000, now abandoned.

(30) Foreign Application Priority Data
Aug. 7, 1998 (CH) 1645/98

(51) Int. Cl. G21K 7/00

(52) U.S. Cl. 378/43

(57) ABSTRACT

The invention relates to a surgical microscope (1) whose surface is at least partly provided with an incorporated bactericidal and/or fungicidal material. This surface part (A-D) comprises at least one carrier material (15) with an incorporated bactericidal and/or fungicidal material dispersed therein in the form of nanoparticles having a size of <20 nm. Accordingly, it is intended that at least one carrier material (15) with incorporated bactericidal and/or fungicidal material dispersed therein in the form of nanoparticles (14) having a size of <20 nm be used for at least one part-surface (A-D) of a surgical microscope (1).

### CROSS-REFERENCE TO RELATED APPLICATIONS

The present application claims benefit as a continuation-in-part of U.S. patent application Ser. No. 10/374,365 filed Feb. 25, 2003, which is a continuation of U.S. patent application Ser. No. 09/529,144 filed Apr. 7, 2000, which is the U.S. national phase under 35 U.S.C. 371 of International Application No. PCT/EP99/05455 filed Jul. 30, 1999 claiming priority of Swiss Patent Application No. 1645/98 filed Aug. 7, 1998.

### FIELD OF THE INVENTION

The invention relates to a surgical microscope whose surface is provided at least partly with incorporated bactericidal and/or fungicidal nanometal, and to the use of at least one carrier material with incorporated bactericidal and/or fungicidal nanomaterial dispersed therein.

### BACKGROUND OF THE INVENTION

When used in the operating theater, surgical microscopes are exposed to a very wide range of dirt, including blood and bone splashes or the like. Pathogens, too, are present, and not least also those germs which are particularly frequently encountered in hospitals. Attempts are of course made to overcome this dirt and these germs with disinfecting cleaning liquids. In the case of the structured surface of the surgical microscope, however, the cleaning effect is only very slight. Dirt may accumulate in the corners and enable germs to settle there, grow and propagate particularly readily. It is known that these hospital germs spread when there is inadequate hygiene in the hospital.

In addition to cleaning, surgical microscopes are surrounded with a drape, a sterile protective covering, when there are sterility requirements, such as, for example, in neurosurgery. In ophthalmology, the microscope is not draped. In this case, a high level of cleanliness and freedom from germs are particularly important.

Apart from this set of problems, solutions for reducing the germ contamination of all equipment and in particular of surgical microscopes and also for ensuring this for as long a time as possible are generally sought in surgery. This serves for ensuring general hospital hygiene, which is attracting more and more attention. In particular, the BSE problem (so-called “mad cow disease”) has led to greater stringency in this respect.

Initial proposals have been made, for example, in the Applicant's patent application publication US-A1-2003/0157151. It is proposed therein to achieve germ reduction by means of a special structuring of the surface which prevents the deposition of dirt and bacteria or makes this more difficult. In this context, the destruction of germs—known per se—by means of metallic or ionic silver or other metals having a germicidal effect is also mentioned. The present Application is therefore filed as a continuation in part in the U.S.A to the Patent Application U.S. 10/374,365 (publication number U.S. 2003/0157151 A1).

With the improvement of the storage and delayed release of silver ions by the embedding thereof in zeolite, a mineral, it was possible to achieve a certain improvement in the long-term effect. By embedding the silver ions in zeolite as a carrier substance, the silver ions are released to the environment only at the rate at which the sodium ions from the surrounding moisture can carry out an ion exchange with the silver ions through the zeolite carrier.

Coatings are also known, for example, from U.S.-B 1-6436422, a coating comprising hydrophilic polymers with ceramic particles, in which once again antibiotic metal ions (including in particular silver ions) have been incorporated, or metal ions incorporated in microcapsules (U.S.-A1-2003/0118664), the former being covered with a hydrophilic coating; or once again particularly shaped microcapsules having the same properties (U.S.-A1-2003/0118658).

DE 103 52 578 B3 discloses a microtome in which the parts which come into contact with the sample and the section thereof have a coating or are doped for the release of silver ions.

### SUMMARY OF THE INVENTION

It is the object of the present invention to provide an improved germ-reducing or even germicidal coating or treatment for surgical microscopes. This coating or treatment should in particular include the outer surfaces of the surgical microscope, but also the inner surfaces thereof and also the optical components, such as, for example, the main objective lens and the eyepieces or eyepiece cups.

The treatment of surgical microscope surfaces with silver ions by one of the known methods is, however, not suitable for an operating theater. In many cases, operating theaters are in fact illuminated with UV radiation during the night in order to achieve a germicidal effect thereby. However, this UV irradiation causes discoloration of the surface. As described above, however, treatment of the optical components is also desired according to the invention and discoloration of these would be unacceptable.

The inventor recognized that no discoloration occurs, and there is simultaneously a substantially improved bactericidal effect, with the nanosilver developed, for example, by the Fraunhofer Institute and BioGate from Bremen, Germany. This nanosilver is partly described in the Laid-Open Application DE-A1-197 56 790.

The inventor recognized that, with the nanosilver described hereby, a UV-stable and highly effective bactericidal substance was produced which meets the requirements for a corresponding surface of a surgical microscope for achieving the object.

This nanosilver can be introduced into finishes and other substances (cements, plastics) and displays its effectiveness there. The use of nanosilver in the housing finish is particularly suitable for a surgical microscope.

The nanosilver can also be incorporated in the cement substances which are used for cementing the lenses.

Furthermore, the introduction of nanosilver into plastic or rubber parts of the surgical microscope, for example into the eyepiece cups or handles or other operating devices, is very expedient.

As a fungicidal measure, it is furthermore envisaged according to the invention to treat the interior of the surgical microscope with a nanosilver finish. In principle, all coated parts of the surgical microscope can be treated in this manner. Surfaces which have been “bare” to date can, according to the invention, be provided with a corresponding clear coat.

The lenses of a surgical microscope are glued in with cement. By equipping this cement with corresponding nanosilver particles, it is possible to prevent fungi and bacteria from settling at the edge of the lenses. The lenses themselves may also be treated at the edge with a corresponding clear coat.

On the other hand, the lens surfaces may be treated with a nano clear coat or corresponding nano AR (antireflection) coats, which in turn may be doped with nanoparticles.

The use is not only limited to nanosilver but also includes all other metals which can be produced in the nano range and have a bactericidal effect.

Further developments of the invention are given in the figures and in the dependent patent claims.

The list of reference numerals is part of the disclosure.

### BRIEF DESCRIPTION OF THE DRAWING VIEWS

The invention is explained in more detail schematically and by way of example with reference to figures.

The figures are described in relation to one another and as whole. Identical reference numerals denote identical components, and reference numerals with different indices indicate functionally identical or similar components.

FIG. 1 shows a schematic setup of a surgical microscope according to the invention, with the places which are shown as detailed views A-D in the following figures;

FIG. 2 shows a detailed view A of an eyepiece cup according to the invention;

FIG. 3 shows a detailed view B as a sectional diagram of a microscope housing according to the invention;

FIG. 4 shows a detailed view C of a handle according to the invention and

FIG. 5 shows a detailed view as a sectional diagram of a main objective lens cemented in and treated according to the invention.

### DETAILED DESCRIPTION OF THE INVENTION

Highly porous metal particles can be produced as a dry nanosilver powder by noble gas vaporization with subsequent condensation. The highly porous structure thereof leads to a substantially increased possible exchange area. The agglomerated particles have a main particle size of 5-10 μm with a specific surface area of 4-6 m2/g. The primary particles are of the order of magnitude of 50-100 nm. Furthermore, it is possible to prepare nanodispersions by vacuum condensation onto flowing liquids (modified sputter method). The main particle size of the (for example) silver particles which are produced by this method is between 5 and 20 nm.

The nanosilver produced by one of the two methods can then be mixed with, for example, silicones (from a concentration of 0.1% by weight), PVC (from a concentration of 0.4% by weight), polyurethane or other materials, liquids or finishes by conventional polymer preparation technologies and even from said concentrations exhibits a very good and long-lasting effect which is not only bacteriostatic but bactericidal. Tests with Staphylococcus aureus, Staphylococcus epidermis and Streptococcus, types of bacteria which can be overcome today with antibiotics only with difficulty and in very high doses, were carried out.

Suitable carrier materials for the nanosilver are numerous materials, such as, for example, the rubber of an eyepiece cup or the plastic of a handle or of a holder on the microscope. In order to keep the surface, for example of the microscope housing and/or of its stand, germ-free, a polymeric binder is preferably used as carrier material.

Such polymeric binders are known to the person skilled in the art for a very wide range of applications, such as, for example, polyethers, polyamides, polyesters, polyolefins, polyurethanes, polyvinyls, polyacrylates, etc., copolymers and terpolymers or mixed polymers also being possible. Where bactericidal and/or fungicidal ceramic material is used, a hydrophilic polymer may be advantageous.

Depending on which surfaces or part-surfaces are relevant, the proportion of the nanoparticles in the carrier material may optionally vary. Even a proportion of from 1 to 500 ppm can result in a substantial improvement. However, it has been found that the proportion of the nanoparticles in the carrier material should preferably be from 0.1 to 30% by volume, preferably from 1 to 10% by volume.

If the numbers just mentioned are considered, it is clear that they may change when the volume of the particles increases, i.e. that sufficient freedom from germs may be found even with a lower proportion by volume in the case of a smaller particle size. On the other hand, however, an undesired increase in volume may result from agglomeration of the particles. It is therefore desirable and advantageous if such agglomeration is avoided so that the material particles are dispersed in substantially isolated form in the carrier material finally doped with the particles. “In substantially isolated form” is intended to mean that not more than 10% of agglomerate particles, preferably not more than 5%, are present in the carrier material.

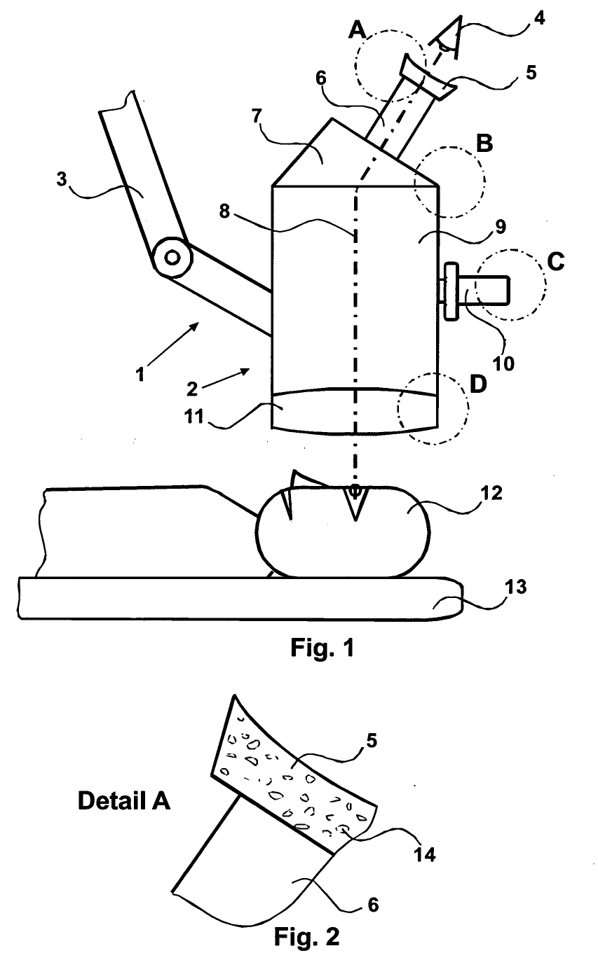

FIG. 1 schematically shows a setup of a surgical microscope 1 which consists of a microscope 2 itself and a stand 3 on which the microscope 2 can be positioned above a patient 12 who is lying on an operating table 13. A surgeon represented schematically by an observer's eye 4 places his eyes against the eyepiece cups 5 (only one is shown from this perspective) and looks through the eyepieces 6 along the axis 8 of the main beam path through the eyepiece tube 7. The microscope housing 9 comprises a main objective lens 11, in addition to components of a microscope which are not shown here. The microscope 2 furthermore has at least one handle 10—not necessarily in the place shown. The detailed views A-D are shown in the following FIGS. 2-5.

FIG. 2 shows the detail A from FIG. 1, namely a magnified view of an eyepiece cup 5 according to the invention which fits on the eyepiece 6. The eyepiece cups 5 consist, for example, of a rubber or silicone in which, for example, 5% by volume of nanosilver particles having a size of about 8 nm have been incorporated as nanoparticles 14 by thorough mixing (and hence with avoidance of agglomerates) and very finely distributed.

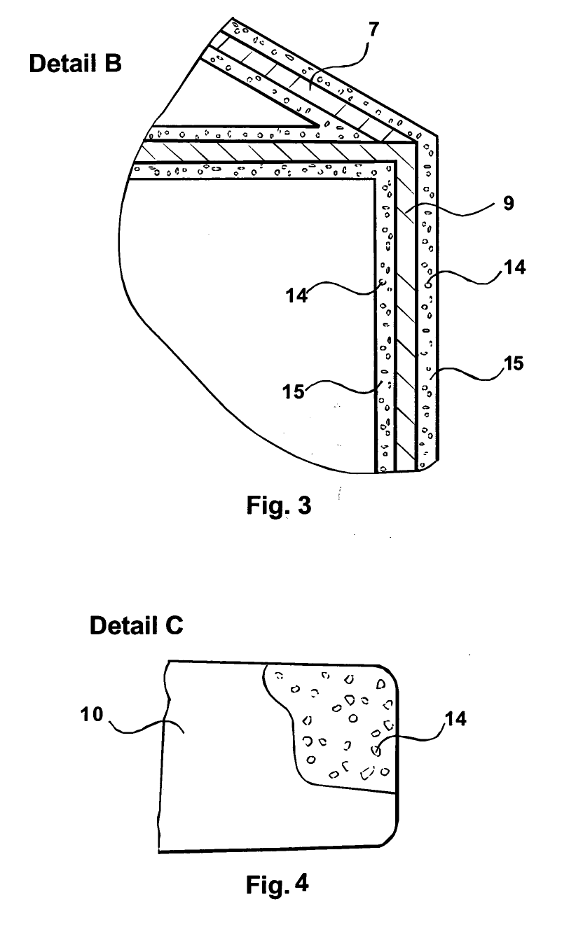

FIG. 3 shows the detail B from FIG. 1. Here, a sectional diagram shows a corner of a microscope housing 9 on which the eyepiece tube 7 is arranged. A carrier material 15 which is equipped with nanoparticles 14 is arranged on both the inner wall and the outer wall.

Here, it is advantageous if the microscope housing 9 is provided with a coat of a plastic as binder and carrier material, such as, for example, a clear coat or a housing finish, to which nanosilver particles of <20 nm, e.g. 5-10 nm, have been added in an average concentration of from 3 to 10% by volume. It may be entirely expedient if not only the outer surface of the microscope housing 9 but (particularly for avoiding fungal infestation) also the inner surface of this microscope housing 9 is provided with a coat in the manner according to the invention—if necessary with finishes which are different but which have a composition according to the invention.

Numerous variants are conceivable in the context of the invention; for example, the carrier material 15 may contain more than one binder. Different further additives for the carrier material 15 are also conceivable, as known to the person skilled in the art for a very wide range of purposes.

Certain compositions which correspond to a possible practical embodiment are also mentioned above for certain parts, but these compositions can be varied by the person skilled in the art according to the requirements.

FIG. 4 shows the detailed view C from FIG. 1. The end of the handle 10 which consists of a material which is equipped with nanoparticles 14 is shown here. Other handles or adjusting wheels or knobs can be equipped in the same manner.

The handle 10 consists, for example, of a polyvinyl acrylate in which 10% by volume of a mixture of copper particles and silver particles (cobalt or nickel is also possible) having a size of about 5 nm have been incorporated.

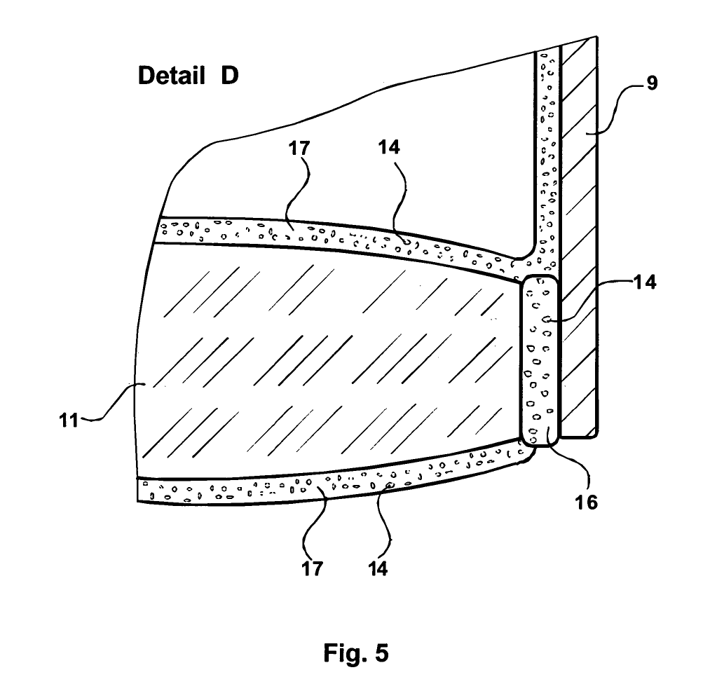

FIG. 5 shows, as detail D from FIG. 1 in the form of a sectional diagram, that the main objective lens 11 in the microscope housing 9 is adhesively bonded by means of an optical cement 16 according to the invention. Nanoparticles 14 are added to the cement 16. Furthermore, the main objective lens is coated—either only at the edge or over its whole area—with a clear coat 17 which also comprises nanoparticles 14. In the case of an antireflection coating of the main objective lens 11 or of the lenses of the eyepiece 6 (in principle, a microscope has such an antireflection coating at each lens/air interface), however, this coating, too, should be doped with nanoparticles for the purposes of the invention.

According to the invention, developments in which the clear coat 17 with nanoparticles 14 is in the form of, and is used as, an optical adhesive for bonding together the various lenses of which a main objective lens usually consists are also conceivable according to the invention. The same use is also possible for the lenses of the eyepiece 6 or of other lenses not shown.

According to the invention, all measures mentioned can be realized either each by itself, but preferably cumulatively.

### LIST OF REFERENCE NUMERALS

Surgical microscope
Microscope
Stand
Observer's eye
Eyepiece cup
Eyepiece
Eyepiece tube
Axis of the main beam path
Microscope housing
Handle
Main objective lens
Patient
Operating table
Nanoparticles
Carrier material
Cement
Clear coat
A-D—Detailed views

1. A surgical microscope (1) whose surface is provided at least partly with an incorporated bactericidal and/or fungicidal material, wherein this surface part (A-D) comprises at least one carrier material (15) with incorporated material dispersed therein in the form of nanoparticles (14) having a size of <300 nm.

2. The surgical microscope (1) as claimed in claim 1, wherein the dispersed incorporated material is incorporated in the form of nanoparticles (14) in a finish as carrier material (15) which covers at least a part of the surface of the surgical microscope (1).

3. The surgical microscope (1) as claimed in claim 1, wherein at least a part of the surface of the stand (3) likewise comprises a carrier material (15) with incorporated metal dispersed therein in the form of nanoparticles (14) having a size of <300 nm.

4. The surgical microscope (1) as claimed in claim 1, wherein the carrier material (15) is a plastic or rubber.

5. The surgical microscope (1) as claimed in claim 4, wherein the dispersed incorporated material in the form of nanoparticles (14) is incorporated in an eyepiece cup (5).

6. The surgical microscope (1) as claimed in claim 4, wherein the dispersed incorporated material in the form of nanoparticles (14) is incorporated in at least one handle (10).

7. The surgical microscope (1) as claimed in claim 1, wherein the dispersed incorporated material in the form of nanoparticles (14) is incorporated in an optical cement material (16) and/or coating material (17) for at least a part of its optical elements (11).

8. The surgical microscope (1) as claimed in claim 1, wherein the dispersed incorporated material in the form of nanoparticles (14) at least partly comprises metal nanoparticles.

9. The surgical microscope (1) as claimed in claim 8, wherein the metal nanoparticles (14) are at least partly silver nanoparticles.

10. The surgical microscope (1) as claimed in claim 1, wherein the size of the dispersed nanoparticles (14) is from 5 to 20 nm, for example from 5 to 10 nm.

11. The surgical microscope (1) as claimed in claim 1, wherein the proportion of the nanoparticles (14) in the carrier material (15) is from 0.1 to 30% by volume, preferably from 1 to 10% by volume.

12. The surgical microscope (1) as claimed in claim 1, wherein the nanoparticles (14) are dispersed in the carrier material (15) in substantially isolated form.

13. The use of at least one carrier material (15) with incorporated bactericidal and/or fungicidal material dispersed therein in the form of nanoparticles (14) having a size of <300 nm for at least one part-surface (A-D) of a surgical microscope (1) and/or of its stand (3).

14. The use of at least one carrier material (15) with incorporated bactericidal and/or fungicidal material dispersed therein in the form of nanoparticles (14) having a size of <300 nm as optical cement (16) for mounting optical elements (11).

15. The use of at least one carrier material (15) with incorporated bactericidal and/or fungicidal material dispersed therein in the form of nanoparticles (14) having a size of <300 nm as a clear coat (17) for surfaces of optical elements (11).

16. The use of at least one carrier material (15) with incorporated bactericidal and/or fungicidal material dispersed therein in the form of nanoparticles (14) having a size of <300 nm as an antireflection coating for surfaces of optical elements (11).

17. The use of at least one carrier material (15) with incorporated bactericidal and/or fungicidal material dispersed therein in the form of nanoparticles (14) having a size of <300 nm as an adhesive for bonding together a plurality of optical elements (11).

18. The use as claimed in claim 13, wherein the dispersed incorporated bactericidal and/or fungicidal material in the form of nanoparticles (14) consists of silver.

19. The use as claimed in claim 14, wherein the dispersed incorporated bactericidal and/or fungicidal material in the form of nanoparticles (14) consists of silver.

20. The use as claimed in claim 15, wherein the dispersed incorporated bactericidal and/or fungicidal material in the form of nanoparticles (14) consists of silver.

21. The use as claimed in claim 16, wherein the dispersed incorporated bactericidal and/or fungicidal material in the form of nanoparticles (14) consists of silver.

22. The use as claimed in claim 17, wherein the dispersed incorporated bactericidal and/or fungicidal material in the form of nanoparticles (14) consists of silver.
